(19) United States
(12) Patent Application Publication
(10) Pub. No.: US 2025/0240367 A1
(43) Pub. Date: Jul. 24, 2025

(54) LIMITED COMMUNICATION SYSTEM FOR HEARING IMPAIRED INDIVIDUALS

(71) Applicant: Aundrea Batton, Kissimmee, FL (US)

(72) Inventor: Aundrea Batton, Kissimmee, FL (US)

(21) Appl. No.: 19/035,233

(22) Filed: Jan. 23, 2025

Related U.S. Application Data
(60) Provisional application No. 63/624,337, filed on Jan. 24, 2024.

(51) Int. Cl. H04M 3/42; G06F 3/01; G06F 3/04817; G06F 3/0488; H04M 1/72469

(52) U.S. Cl. CPC H04M 3/42391; G06F 3/016; G06F 3/04817; H04M 1/72469; G06F 3/0488

(57) ABSTRACT

A limited communication system for hearing impaired individuals includes a plurality of limited communication devices separated into a single primary device and a plurality of secondary devices. Each device includes a main body, a display, a vibration unit, a light, and an internal controller. The primary device displays a listing of each of the secondary devices and functions to send and receive messages with each of the secondary devices. Each of the secondary devices are utilized by a student and displays an icon for contacting the wearer of the primary device. Each of the secondary devices have restricted communication protocols that prevent communications with each other or any devices outside the network. Upon receiving a message from another system device, the vibration unit, the light, and the display screen of the device receiving the message are activated.

### CROSS-REFERENCE TO RELATED APPLICATIONS

This application claims the benefit of U.S. Application Ser. No. 63/624,237 filed on Jan. 24, 2024, the contents of which are incorporated herein by reference.

### TECHNICAL FIELD

The present invention relates generally to communication systems, and more particularly to a limited communication system for hearing impaired individuals.

### BACKGROUND

The statements in this section merely provide background information related to the present disclosure and may not constitute prior art.

Children with hearing disabilities, also referred to as Deaf or Hard of Hearing (DHH) are typically provided with a sign language interpreter when attending school. In this regard, the interpreter remains in the classroom and signs the spoken language lessons from the teacher to the DHH student. This arrangement allows the teacher to teach the entire class without having to focus specifically on one particular child. However, unlike other children who can hear the teacher call their name, the DHH student may not know when they are being called on unless they are looking directly at the teacher or the interpreter. Indeed, it is not uncommon for one or both to have to wave their arms or physically approach the DHH student to get their attention when they need to receive instructions.

Unfortunately, this requirement often makes the DHH student stand out from the other students and can cause undue embarrassment to the child. Although devices such as smartphones may be utilized for a teacher to attempt to surreptitiously get a student's attention, most schools do not permit the use of these devices within the classroom. In this regard, most public and private schools have electronic device policies that restrict or prohibit students from accessing smartphones, tablets or other such devices that are capable of communicating with each other and/or the internet while in class. Such policies are in place to reduce distractions caused by students talking or texting each other, and to reduce or prevent the students from cheating by accessing the internet.

Accordingly, it would be beneficial to provide a communication system for hearing impaired individuals that can allow a teacher or interpreter to discreetly notify the DHH student that they are trying to get his or her attention so as to alleviate these drawbacks. Likewise, it would be beneficial if the student could provide a similar notification to the teacher or interpreter when they are not aware the student is trying to communicate with them.

The present invention, directed to a limited communication system for hearing impaired individuals differs from the conventional art in a number of aspects. The manner by which will become more apparent in the description which follows, particularly when read in conjunction with the accompanying drawings.

### SUMMARY OF THE INVENTION

The present invention is directed to a limited communication system for hearing impaired individuals. One embodiment of the present invention can include a plurality of limited communication devices with one device being designated a primary device, and the remaining devices being designated as secondary devices. Each of the limited communication devices can take the shape of a wristwatch and can include a main body, a display, a vibration unit, a light, and an internal controller.

In one embodiment, the primary device can be utilized by a teacher or caregiver, can display a listing of each of the secondary devices, and can send and receive messages with each of the secondary devices.

In one embodiment, each of the secondary devices can be utilized by a student or hearing impaired individual and can display an icon for contacting the teacher wearing the primary device. Each of the secondary devices can only communicate with the primary device and cannot communicate with each other.

Upon receiving a message from another system device, the vibration unit, the light, and the display screen of the device receiving the message can be activated to provide a visual and tactile notification to the wearer.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a top view of a limited communication device that is useful for understanding the inventive concepts disclosed herein.

FIG. 2 is a simplified block diagram of the system controller of the limited communication device, in accordance with one embodiment of the invention.

FIG. 3 is an exemplary operating environment illustrating a limited communication system, in accordance with one embodiment of the invention.

FIG. 4 is an exemplary flowchart illustrating a method of establishing the limited communication system, in accordance with one embodiment of the invention.

FIGS. 5-8 each illustrate one embodiment of the limited communication system in operation, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

As described herein, a “unit” means a series of identified physical components which are linked together and/or function together to perform a specified function.

Although described below with for use by a DHH child in a classroom setting, this is but one contemplated use of the inventive system. To this end, the system may be used by any individual of any age and in any setting such as school, college, work, or a home environment.

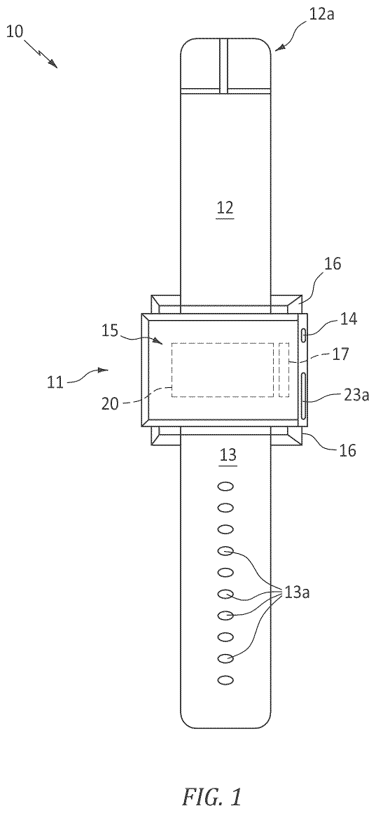

FIG. 1 illustrates one embodiment of a Limited Communication Device (LCD) 10. In the preferred embodiment, the LCD can be constructed so as to resemble a wristwatch that is worn on the wrist of a user. Such a feature is important to allow the device to be generally unobtrusive, and to not draw attention to a DHH individual utilizing the system to communicate. Of course, other embodiments are contemplated wherein the device 10 does not resemble a watch, and may instead resemble a tablet computer or other such device, for example.

As shown in the drawings, the LCD 10 can include a main body 11 having a plurality of surfaces that define a generally hollow and waterproof interior space. The main body can include any number of different shapes and sizes and can be constructed from any number of materials that are, for example, relatively strong and stiff for their weight. Several nonlimiting examples include but are not limited to various metals or metal alloys (e.g., aluminum, steel, titanium, or alloys thereof), plastic/polymers (e.g., high-density polyethylene (HDPE), rigid polyvinyl chloride (PVC), malleable polyethylene terephthalate (PET)), and/or various composite materials.

A pair of elongated wrist bands 12 and 13 can extend outward from two side walls of the main body 11. The wrist bands may be constructed from any number of different materials such as leather, rubber and/or various metals (e.g., aluminum, gold, or silver), and can be selectively joined together via band connectors such as the illustrated buckle 12a and apertures 13a, for example to allow a user to adjust the fit of the device about their wrist.

Although described above with regard to two separate wrist bands that are joined together by a specific type of buckle, this is for illustrative purposes only, as any number of other types of connectors are contemplated. Additionally, the wristband may be constructed as a single band having a stretchable main body or centrally located latch as are known in the art.

In one embodiment, one or more buttons 14 can be positioned along the main body. Each of the buttons can be connected to the below described controller 20 and can function to selectively operate the device.

In one embodiment, a display screen 15 such as an OLED display, for example, that allows two-way communication with a user can be positioned along the top surface 11a of the device. The display screen can be connected to the controller 20 and can function to display information to the user as described below.

In one embodiment, one or more lights 16 can be positioned along the main body. Each of the lights 16 can be positioned anywhere along the main body to produce a clear, distinctive, and visual notification to the wearer of the device that is separate from the illumination and/or lighting elements produced by the display 15 itself.

To this end, the lights 16 can ideally include one or more strips of Light Emitting Diodes that are connected to the controller 20 which operate to selectively produce light in a plurality of different colors, intensities, and/or flashing patterns to provide a visual notification to the user wearing the device that a notification has been received.

In one embodiment, a vibration unit 17 can be connected to, and positioned within the interior space of the main body 11. The vibration unit can be connected to the controller 20 and can function to selectively vibrate the main body 11 to provide a physical notification to the user wearing the device.

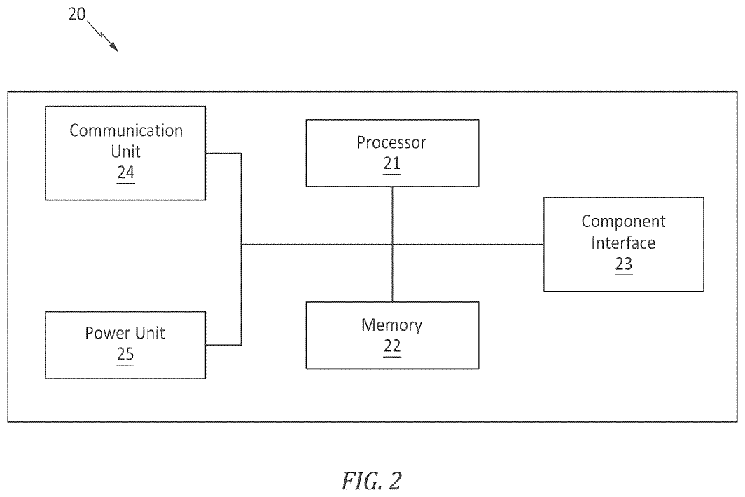

FIG. 2 is a simplistic block diagram illustrating one embodiment of the LCD system controller 20. As shown, one embodiment of the controller 20 can include a processing unit 21 that is conventionally connected to an internal memory 22, a component interface unit 23, a limited wireless communication unit 24, and/or a power unit 25.

Although illustrated as separate elements, those of skill in the art will recognize that one or more system components 21-25 may include, comprise, or consist of one or more printed circuit boards (PCB) containing any number of integrated circuit or circuits for completing the activities described herein. The CPU may be one or more integrated circuits having firmware for causing the circuitry to complete the activities described herein. Of course, any number of other analog and/or digital components capable of performing the described functionality can be provided in place of, or in conjunction with the described elements.

The processing unit 21 can include one or more central processing units (CPU) or any other type of device, or multiple devices, capable of manipulating or processing information such as program code stored in the memory 22 in order to allow the device to perform the functionality described herein.

Memory 22 can act to store operating instructions in the form of program code for the processing unit 21 to execute. Although illustrated in FIG. 2 as a single component, memory 22 can include one or more physical memory devices such as, for example, local memory and/or one or more bulk storage devices. As used herein, local memory can refer to random access memory or other non-persistent memory device(s) generally used during actual execution of program code, whereas a bulk storage device can be implemented as a persistent data storage device such as a solid-state hard drive, for example.

The component interface unit 23 can function to provide a communicative link between the processing unit 21 and various system elements such as the push buttons 14, the display 15, the lights 16, and the vibration unit 17, among others, for example. In this regard, the component interface unit can include any number of different components such as one or more PIC microcontrollers, standard bus, internal bus, connection cables, and/or associated hardware capable of linking the various components.

In one embodiment, the component interface unit can include, or can be connected to one or more cable receptacles/plugs such as a USB-C port 23a, or other such receptacles that are capable of engaging a power or communication cable.

The wireless communication unit 24 can include, comprise, or consist of a limited range wireless transceiver such as a Bluetooth or Wi-Fi transceiver, for example that is hard coded to communicate only with another system LCD. To this end, the communication unit 24 and/or its respective memory components are specifically constructed to be unable to connect with any type of voice, text or data networks, and/or any type of internet capable device, and instead will only connect to the wireless communication unit of another LCD via a direct device-to-device wireless connection.

The power unit 25 can function to supply the required power to each of the system components. In one embodiment, the power unit can include one or more onboard batteries which may be recharged via the communication port 23a, for example. In one embodiment, the power unit can also include a wireless charging unit to permit the device to be charged in a wireless manner.

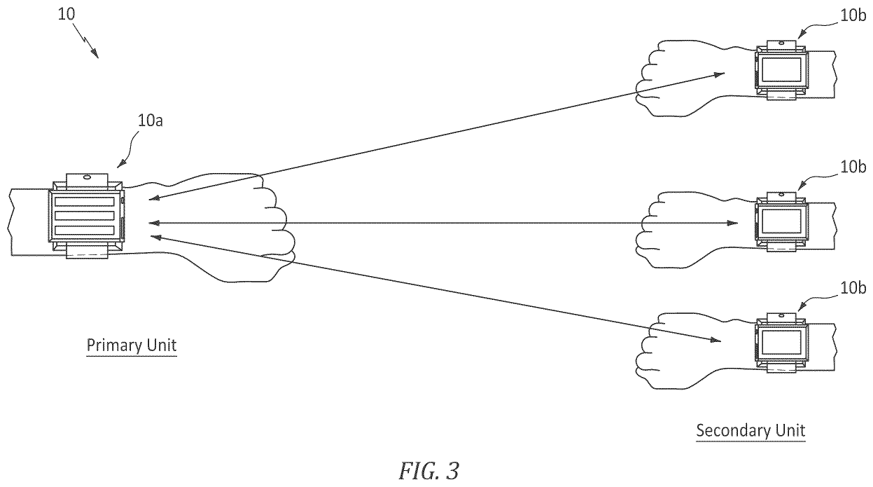

In operation, a plurality of Limited Communication Devices can be connected together to form a limited communication system. FIG. 3 illustrates one embodiment of a system operating environment 100 comprising a plurality of LCD devices. In the illustrated embodiment, the system is utilized in a classroom environment between a teacher/caregiver and one or more students. As such, one LCD device 10a is configured for use as the Primary system device for use by a teacher, and each of the others are configured as secondary devices 10b for use by students.

In this regard, each of the primary and secondary devices 10a and 10b are identical to each other as described above with regard to device 10; however each device will be hard coded with instructions that limit its communications with other system devices based on the assigned role (e.g., Primary or Secondary).

Specifically, the Primary device 10a will be able to securely and simultaneously communicate with each of the Secondary devices 10b via a direct and secure wireless connection; whereas each of the Secondary devices 10b will only be able to communicate with the Primary device 10a and not with each other.

As noted above, the wireless communication unit of each device will comprise a limited range (e.g., 50′ to 500′) local wireless transceiver utilizing a communication protocol such as Wi-Fi, Bluetooth, or encrypted radio transmissions, for example, that is capable of only connecting with another system LCD to produce a direct device-to-device network between a single Primary device and one or more Secondary devices. As will be described below, utilizing a direct and limited range communication protocol is a critical feature of the system 10 as it provides a direct and secure means for sending a notification to or from a student and teacher/caregiver operating an LCD without violating the electronic device policies of most schools.

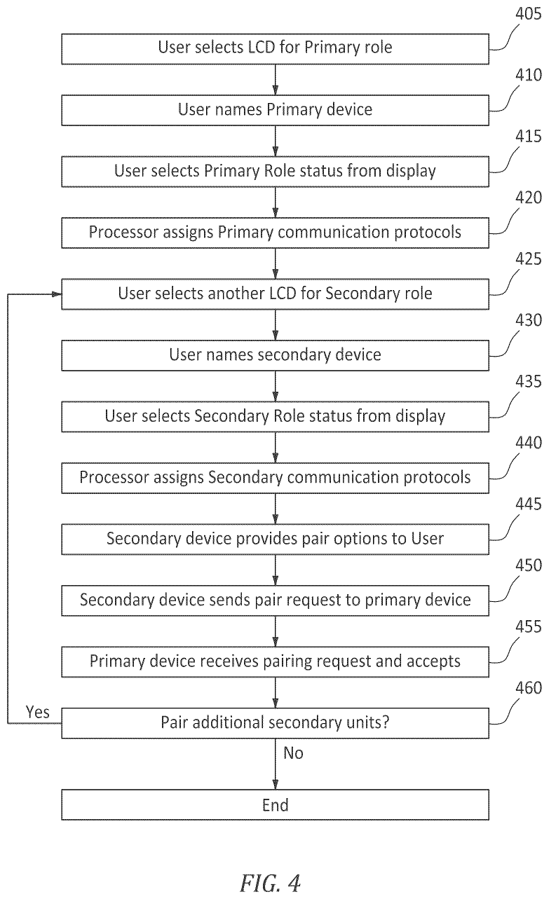

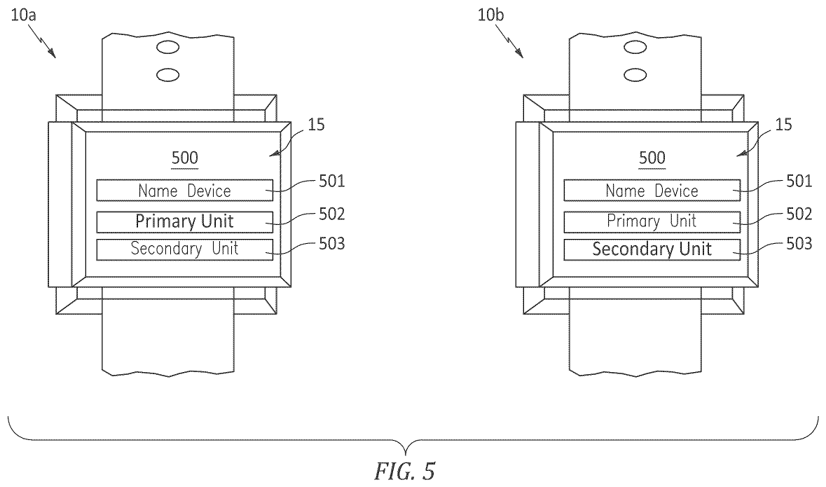

FIGS. 4-6 illustrate one embodiment of a method 400 of configuring the system devices and several exemplary presentation screens. In this regard, the method can begin at step 405 where a user selects an LCD device to function as the Primary system device 10a and powers on the device. As shown at FIG. 5, upon powering on the device 10a, the display screen 15 can generate a presentation screen 500 and provide options for allowing the user to name the device 501. As such, the user can provide the name of the device user—e.g., “Ms. Smith” at step 410.

Next, the method can proceed to step 415 where the user can select the role of the device 10a from the display screen as a Primary unit 502 or a Secondary unit 503. Upon selecting the unit will operate as the Primary unit 502, the method will proceed to step 420 where the processor will assign primary communication protocols to the wireless transceiver. More specifically, the processor will enable the communication unit to permit and perform simultaneous communication with each of the Secondary units that are paired with the system as described below.

Next, the method can proceed to step 425 the user selects another LCD device to function as a Secondary unit and powers on the device. As shown at FIG. 5, upon powering on the device 10b, the display screen 15 of that unit will also generate presentation screen 500 and provide options for allowing the user to name the device 501. As such, the user can provide the name of the device user—e.g., “Bobby” at step 430.

Next, the method can proceed to step 435 where the user can select the role of the unit from the display screen as a Primary unit 502 or a Secondary unit 503. Upon selecting the Secondary unit 503, the method will proceed to step 440 where the processor will assign secondary communication protocols to the wireless transceiver. More specifically, the processor will enable the communication unit of the device 10b to permit and perform communication only with the Primary unit 10a it is paired with.

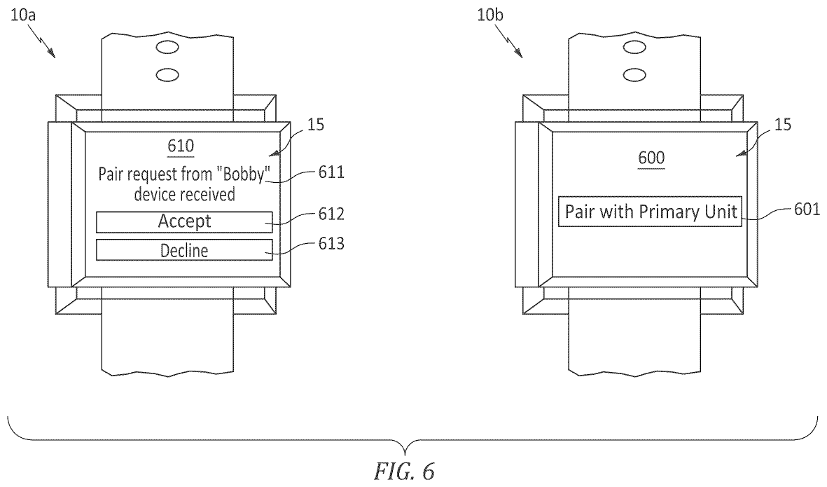

Next, the method can proceed to step 445 where the device 10b can be paired (i.e., establish a communicative link) with the primary unit 10a. As shown at FIG. 6, upon selecting the Secondary device option at step 435, the display screen 15 of the secondary unit 10b can generate a presentation screen 600 with options for pairing with a primary device 601. Upon selecting the “Pair” option, the method proceeds to step 450 where the pair request is sent to the primary unit.

At step 455, the display screen 15 of the primary unit 10a can generate presentation screen 610 that displays a message 611 indicating the pair request from the Secondary Unit. The screen can provide the user with options to accept 612 or decline reject 613 the pair request. At step 460, the user can select yes to pair another Secondary Unit wherein the method will return to step 425, otherwise the user will select no, and the method will end.

Upon completing the pairing process between the primary and secondary units, each device will be able to communicate as outlined below.

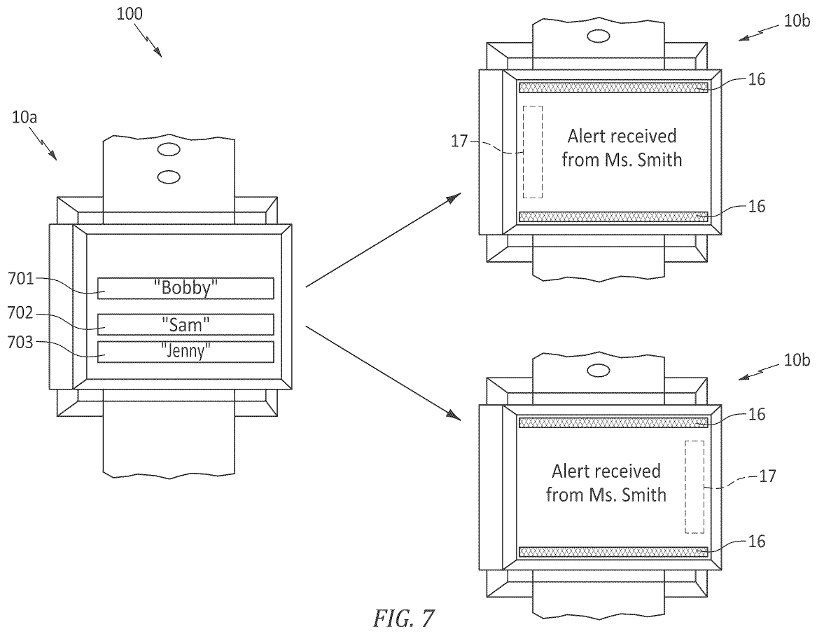

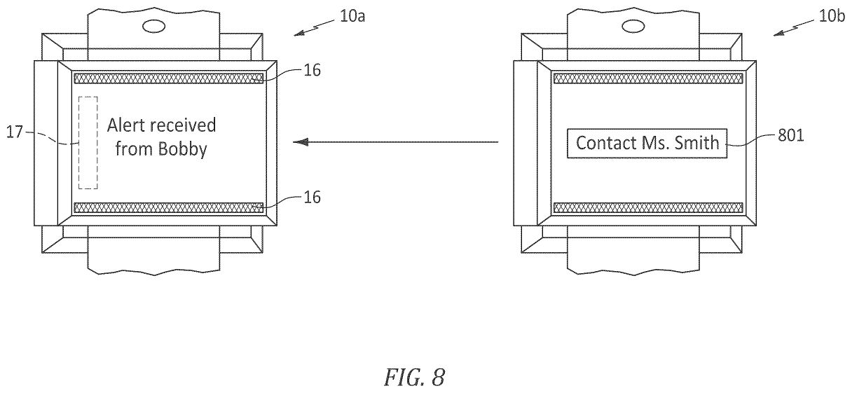

FIGS. 7 and 8 illustrate one embodiment of the system in operation to perform limited communication. As shown at FIG. 7 the display screen of the Primary LCD 10a can continuously display icons 701-703 corresponding to the name of each user wearing a Secondary LCD 10b that is paired to the Primary unit. In a situation where the teacher wearing the Primary LCD 10a wishes to get the attention of a specific student such as “Bobby”, and/or “Sam”, for example, the teacher can touch the icon 701 and/or 702 on their screen.

Upon selecting the icon, the device 10a will send an alert signal to the selected secondary devices 10b. Upon receiving the signal from the Primary LCD 10a, each of the Secondary LCD's 10b will activate one or both of the light 16 or vibration unit 17 based on the individually configured user settings of that device. Simultaneously with the activation, the display screen can show a message indicating the name of the Primary device wearer, so the student knows the teacher is trying to get their attention.

Finally, as shown at FIG. 8, the display for each of the Secondary LCD's 10b can continuously display icon 801 corresponding to the name of each user wearing the Primary LCD 10a (e.g., “Ms. Smith”). When a student needs to get the teachers attention, they can touch the icon 801 on their screen which will cause their device 10b to send an alert signal to the Primary LCD 10a. Upon receiving a signal from a Secondary LCD, the Primary LCD will activate one or both of its lights 16 or vibration unit 17 based on the individually configured user settings of that device. Simultaneously with the activation, the display screen can show a message indicating the name of the student who sent the request.

Accordingly, the inventive device and system described herein provides a novel way for DHH students and teachers to send discrete and limited signals to get the attention of each other. Critically, because none of the system devices are able to access any outside networks such as text systems, voice systems, or the internet, for example, the inventive system is fully compliant with school policies prohibiting the use of electronic communication devices.

As to a further description of the manner and use of the present invention, the same should be apparent from the above description. Accordingly, no further discussion relating to the manner of usage and operation will be provided.

As described herein, one or more elements of the device 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the term “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A limited communication system, comprising:
a primary device having a main body, a display, and an internal controller; and
at least one secondary device having a main body, a display, and an internal controller,
wherein the primary device is configured to communicate wirelessly with each of the at least one secondary device.

2. The system of claim 1, wherein the primary device and the at least one secondary device each includes a vibration unit that is configured to selectively vibrate.

3. The system of claim 1, wherein the primary device and the at least one secondary device each includes one or more lights that are configured to be selectively illuminated.

4. The system of claim 3, wherein the display of the primary device is configured to show a selectable icon for each of the at least one secondary device.

5. The system of claim 4, wherein the primary device is configured to send a notification to the at least one secondary device associated with the icon selected by a user.

6. The system of claim 5, wherein the vibration unit of the at least one secondary device associated with the icon selected by the user is configured to activate unit upon receipt of the notification.

7. The system of claim 5, wherein the light of the at least one secondary device associated with the icon selected by the user is configured to activate upon receipt of the notification.

8. The system of claim 5, wherein the display of the at least one secondary device associated with the icon selected by the user is configured to show a notification message unit upon receipt of the notification.

9. The system of claim 3, wherein the display of each of the at least one secondary device is configured to show a selectable icon for the primary device.

10. The system of claim 9, each of the at least one secondary device is configured to send a notification to the primary device upon the icon being selected by a user.

11. The system of claim 10, wherein the vibration unit of the primary device is configured to activate upon receipt of the notification.

12. The system of claim 11, wherein the light of the primary device is configured to activate upon receipt of the notification.

13. The system of claim 12, wherein the display of the primary device is configured to show a notification message unit upon receipt of the notification.

14. The system of claim 3, wherein the display of the primary device comprises a touch screen display, and
wherein the display of each of the at least one secondary device comprises a touch screen display.

15. The system of claim 1, wherein the primary device further comprises:
a wristband that is connected to the main body, said wristband being configured to secure the main body to a wrist of a user.

16. The system of claim 1, wherein each of the at least one secondary device further comprises:
a wristband that is connected to the main body, said wristband being configured to secure the main body to a wrist of a user.
